(19) United States
(12) Patent Application Publication
(10) Pub. No.: US 2021/0071280 A1
(43) Pub. Date: Mar. 11, 2021

(54) GRAIN-ORIENTED ELECTRICAL STEEL SHEET AND MANUFACTURING METHOD THEREFOR

(71) Applicant: POSCO, Pohang-si, Gyeongsangbuk-do (KR)

(72) Inventors: Kyu-Seok HAN, Pohang-si, Gyeongsangbuk-do (KR); Jae Kyoum KIM, Pohang-si, Gyeongsangbuk-do (KR); Chang Soo PARK, Pohang-si, Gyeongsangbuk-do (KR); Jin-Wook SEO, Pohang-si, Gyeongsangbuk-do (KR); Jong-Tae PARK, Pohang-si, Gyeongsangbuk-do (KR)

(21) Appl. No.: 16/958,195

(22) PCT Filed: Dec. 17, 2018
(86) PCT No.: PCT/KR2018/016038

§ 371 Date: Jun. 26, 2020

(30) Foreign Application Priority Data
Dec. 26, 2017 (KR) 10-2017-0179926

(51) Int. Cl. C21D 9/46; C21D 8/12; C21D 6/00; C22C 38/60; C22C 38/22; C22C 38/20; C22C 38/32; C22C 38/34; C22C 38/04; C22C 38/00; H01F 1/147

(52) U.S. Cl. CPC C21D 9/46; C22C 2202/02; C21D 8/1233; C21D 8/1272; C21D 6/008; C21D 6/005; C22C 38/60; C22C 38/22; C22C 38/20; C22C 38/32; C22C 38/34; C22C 38/04; C22C 38/008; C22C 38/002; C22C 38/001; H01F 1/147; C21D 2201/05; C21D 8/1222

(57) ABSTRACT

A grain-oriented electrical steel sheet according to an embodiment of the present invention contains, in a unit of wt %, Si at 2.0 wt % to 4.5 wt %, C at 0.005 wt % or less (excluding 0 wt %), Mn at 0.001 wt % to 0.08 wt %, P at 0.001 wt % to 0.1 wt %, Cu at 0.001 wt % to 0.1 wt %, S at 0.0005 wt % to 0.05 wt %, Se at 0.0005 wt % to 0.05 wt %, B at 0.0001 wt % to 0.01 wt %, Mo at 0.01 wt % to 0.2 wt %, and the remainder of Fe and inevitable impurities. A sum amount of S and Se is 0.005 to 0.05 wt %.

### TECHNICAL FIELD

The present invention relates to a grain-oriented electrical steel sheet and a manufacturing method therefor. Specifically, the present invention relates to a grain-oriented electrical steel sheet and a manufacturing method therefor that may be excellent in productivity and in magnetism by stably growing crystal grains with a very high degree of integration in a Goss direction during secondary recrystallization high temperature annealing using S- and Se-based precipitates. More specifically, the present invention relates to a method for manufacturing a grain-oriented electrical steel sheet and a manufacturing method therefor that may be excellent in productivity and in magnetism by controlling Mn, S, Se, Cu, B, and Mo components in an alloy component.

### BACKGROUND ART

A grain-oriented electrical steel sheet is a soft magnetic material used as an iron core for electronic equipment that has excellent magnetic properties in a rolling direction and requires excellent magnetic properties in one direction, such as for a transformer, and it is made by forming a Goss texture ({110}<001> texture) on an entire steel sheet by using an abnormal grain growth phenomenon called secondary recrystallization.

Generally, magnetic properties may be described by a magnetic flux density and iron loss, and a high magnetic flux density may be obtained by precisely arranging an orientation of grains in a {110}<001> orientation. The electrical steel sheet having a high magnetic flux density not only makes it possible to reduce a size of an iron core material of an electrical device, but also reduces hysteresis loss, thereby achieving miniaturization and high efficiency of the electrical device at the same time. Iron loss is power loss consumed as heat energy when an arbitrary alternating magnetic field is applied to a steel sheet, and it largely changes depending on a magnetic flux density and a thickness of the steel sheet, an amount of impurities in the steel sheet, specific resistance, and a size of a secondary recrystallization grain, wherein the higher the magnetic flux density and the specific resistance and the lower the thickness and the amount of impurities in the steel sheet, the lower the iron loss and the higher the efficiency of the electrical device.

Unlike typical grain growth, the secondary recrystallization of the grain-oriented electrical steel sheet occurs when movement of the grain boundary in which grains normally grow is suppressed by precipitates, inclusions, or elements that are dissolved or segregated in the grain boundaries. In addition, in order to grow grains with a high degree of integration with respect to the Goss orientation, complex processes such as component control in steel making, slab reheating and hot rolling process factor control in hot rolling, hot rolled sheet annealing heat treatment, primary recrystallization annealing, and secondary recrystallization annealing, are required, and these processes should also be managed very accurately and rigorously. As described above, the precipitates and inclusions that inhibit the grain growth are specifically referred to as grain growth inhibitors, and studies on a production technology of the grain-oriented electrical steel sheets by the secondary recrystallization of Goss orientation have focused on securing superior magnetic properties by using a strong grain growth inhibitor to form secondary recrystallization with high integration to Goss orientation.

MnS was used as a grain growth inhibitor in the grain-oriented electrical steel sheet which was initially developed, and it was manufactured by a method of cold rolling two times. Accordingly, the secondary recrystallization was stably formed, but the magnetic flux density was not so high and the iron loss was high.

Thereafter, a method of manufacturing a grain-oriented electrical steel sheet by using a combination of AlN and MnS precipitates and then cold rolling once has been proposed. Recently, a grain-oriented electrical steel sheet manufacturing method in which secondary recrystallization is caused by an Al-based nitride exhibiting a strong grain growth inhibiting effect by supplying nitrogen into the steel sheet through a separate nitriding process using ammonia gas after decarburizing after cold rolling once without using MnS has been proposed.

So far, a manufacturing method in which precipitates such as AlN and MnS [Se] are used as the grain growth inhibitor to cause secondary recrystallization have been mainly used. Such a manufacturing method has an advantage of stably forming secondary recrystallization, but in order to having a strong grain growth inhibiting effect, the precipitates should be distributed very finely and uniformly in the steel sheet. In order to uniformly distribute the fine precipitates in this manner, a slab should be heated at a high temperature for a long period of time before hot rolling to dissolve coarse precipitates present in the steel, and then hot rolled in a very short time to complete the hot rolling without precipitation. This requires large-sized slab heating equipment, and in order to minimize precipitation as much as possible, there are restrictions that hot rolling and a winding process must be strictly controlled in order to suppress the precipitation as much as possible, and that the precipitates solidified in a hot rolled sheet annealing step after hot rolling should be controlled so as to be finely precipitated. In addition, when the slab is heated at a high temperature, a slab washing phenomenon occurs due to formation of Fe₂SiO₄ having a low melting point, thereby decreasing actual yields.

In addition, a manufacturing method of a grain-oriented electrical steel sheet is proposed in which secondary recrystallization is formed by minimizing the impurity content in the steel sheet without using precipitates and maximizing a difference in grain boundary mobility depending on the crystal orientation. In this technique, it has been proposed to reduce the content of Al and to control the content of B, V, Nb, Se, S, P, and N to a very small amount, but it is shown that a small amount of Al should form precipitates or inclusions to stabilize the secondary recrystallization.

In addition, attempts have been made to use various precipitates such as TiN, VN, NbN, and BN as a grain growth inhibitor, but due to thermal instability and an excessively high precipitate decomposition temperature, formation of stable secondary recrystallization has failed.

### [Disclosure]

The present invention has been made in an effort to provide a grain-oriented electrical steel sheet and a manufacturing method of the grain-oriented electrical steel sheet. Specifically, the present invention has been made in an effort to provide a grain-oriented electrical steel sheet and a manufacturing method of the grain-oriented electrical steel sheet that may be excellent in productivity and in magnetism by stably growing crystal grains with a very high degree of integration in a Goss direction during secondary recrystallization high temperature annealing using S- and Se-based precipitates. More specifically, the present invention has been made in an effort to provide a grain-oriented electrical steel sheet and a manufacturing method of the grain-oriented electrical steel sheet that may be excellent in productivity and in magnetism by controlling Mn, S, Se, Cu, B, and Mo components in an alloy component.

An embodiment of the present invention provides a grain-oriented electrical steel sheet, containing, in a unit of wt %, Si at 2.0 wt % to 4.5 wt %, C at 0.005 wt % or less (excluding 0 wt %), Mn at 0.001 wt % to 0.08 wt %, P at 0.001 wt % to 0.1 wt %, Cu at 0.001 wt % to 0.1 wt %, S at 0.0005 wt % to 0.05 wt %, Se at 0.0005 wt % to 0.05 wt %, B at 0.0001 wt % to 0.01 wt %, Mo at 0.01 wt % to 0.2 wt %, and the remainder of Fe and inevitable impurities. A sum amount of S and Se is 0.005 to 0.05 wt %.

The grain-oriented electrical steel sheet may further contain B at 0.0011 to 0.01 wt %.

The grain-oriented electrical steel sheet may further contain Al at 0.0001 to 0.01 wt % and N at 0.0005 to 0.005 wt %.

The grain-oriented electrical steel sheet may further contain at least one of Cr at 0.001 to 0.1 wt %, Sn at 0.005 to 0.2 wt %, and Sb at 0.005 to 0.2 wt %.

Another embodiment of the present invention provides a manufacturing method of a grain-oriented electrical steel sheet, including: preparing a slab that contains, in a unit of wt %, Si at 2.0 wt % to 4.5 wt %, C at 0.005 wt % or less (excluding 0 wt %), Mn at 0.001 wt % to 0.08 wt %, P at 0.001 wt % to 0.1 wt %, Cu at 0.001 wt % to 0.1 wt %, S at 0.0005 wt % to 0.05 wt %, Se at 0.0005 wt % to 0.05 wt %, B at 0.0001 wt % to 0.01 wt %, Mo at 0.01 wt % to 0.2 wt %, and the remainder of Fe and inevitable impurities, and in which a sum amount of S and Se is 0.005 to 0.05 wt %; heating the slab; hot rolling the slab to prepare a hot rolled sheet; cold rolling the hot rolled sheet to prepare a cold rolled sheet; primary recrystallization annealing the cold rolled sheet; and secondary recrystallization annealing the cold rolled sheet in which the first recrystallization annealing is completed.

After the preparing of the hot rolled sheet, the hot rolled sheet may have an edge crack maximum depth of 20 mm or less.

The cold rolled sheet in which the first recrystallization annealing is completed may include one or more precipitates of (Fe,Mn,Cu)S and (Fe,Mn,Cu)Se.

The primary recrystallization annealing may be performed in a hydrogen and nitrogen mixed atmosphere at a dew point temperature of 50° C. to 70° C.

Magnetism of the grain-oriented electrical steel sheet according to the embodiment of the present invention is excellent by controlling components of Mn, S, Se, Cu, B, and Mo in an alloy component and by stably growing crystal grains with a very high degree of integration in a Goss direction during secondary recrystallization high temperature annealing using S- and Se-based precipitates, in which it is easy to control the precipitates.

### DESCRIPTION OF THE DRAWINGS

FIG. 1 illustrates a TEM photograph of precipitates immediately before secondary recrystallization in a manufacturing process of Inventive Material 5.

FIG. 2 illustrates a graph of composition analysis of precipitates.

FIG. 3 to FIG. 7 illustrate results of mapping precipitates for each component of Fe, Mn, Cu, S, and Se.

FIG. 8 illustrates a photograph of a grid diffraction pattern for precipitates.

### MODE FOR INVENTION

It will be understood that, although the terms first, second, third, etc. may be used herein to describe various elements, components, regions, layers, and/or sections, they are not limited thereto. These terms are only used to distinguish one element, component, region, layer, or section from another element, component, region, layer, or section. Therefore, a first part, component, area, layer, or section to be described below may be referred to as second part, component, area, layer, or section within the range of the present invention.

The technical terms used herein are to simply mention a particular embodiment and are not meant to limit the present invention. An expression used in the singular encompasses the expression of the plural, unless it has a clearly different meaning in the context. In the specification, it is to be understood that the terms such as “including”, “containing”, “having”, etc., are intended to indicate the existence of specific features, regions, numbers, stages, operations, elements, components, and/or combinations thereof disclosed in the specification, and are not intended to preclude the possibility that one or more other features, regions, numbers, stages, operations, elements, components, and/or combinations thereof may exist or may be added.

When referring to a part as being “on” or “above” another part, it may be positioned directly on or above the other part, or another part may be interposed therebetween. In contrast, when referring to a part being “directly above” another part, no other part is interposed therebetween.

Unless otherwise defined, all terms used herein, including technical or scientific terms, have the same meanings as those generally understood by those with ordinary knowledge in the field of art to which the present invention belongs. Terms defined in commonly used dictionaries are further interpreted as having meanings consistent with the relevant technical literature and the present disclosure, and are not to be construed as having idealized or very formal meanings unless defined otherwise.

Unless otherwise stated, % means % by weight, and 1 ppm is 0.0001% by weight.

Further, in exemplary embodiments of the present invention, inclusion of an additional element means replacing the remaining iron (Fe) by an additional amount of the additional elements.

The present invention will be described more fully hereinafter, in which exemplary embodiments of the invention are shown. As those skilled in the art would realize, the described embodiments may be modified in various different ways, all without departing from the spirit or scope of the present invention.

A grain-oriented electrical steel sheet according to an embodiment of the present invention contains, in a unit of wt %, Si at 2.0 wt % to 4.5 wt %, C at 0.005 wt % or less (excluding 0 wt %), Mn at 0.001 wt % to 0.08 wt %, P at 0.001 wt % to 0.1 wt %, Cu at 0.001 wt % to 0.1 wt %, S at 0.0005 wt % to 0.05 wt %, Se at 0.0005 wt % to 0.05 wt %, B at 0.0001 wt % to 0.01 wt %, Mo at 0.01 wt % to 0.2 wt %, and the remainder of Fe and inevitable impurities.

Hereinafter, the reason for limiting the components of the grain-oriented electrical steel sheet will be described.

Si at 2.0 to 4.5 wt %

Silicon (Si) increases specific resistance of the grain-oriented electrical steel sheet, and thus serves to decrease core loss, that is, iron loss. When the Si content is too small, the specific resistance decreases, eddy current loss increases, and thus the iron loss may deteriorate. In addition, during primary recrystallization annealing, phase transformation between ferrite and austenite occurs, a primary recrystallized texture may be severely damaged. In addition, phase transformation between ferrite and austenite occurs during second recrystallization annealing, thus the second recrystallization may become unstable, and a Goss texture may be severely damaged. When the Si content is too high, oxide layers of SiO₂ and Fe₂SiO are excessively and densely formed during decarburization in primary recrystallization annealing, thus decarburization behavior may be delayed. In addition, brittleness of the steel increases, and toughness thereof decreases, so an occurrence rate of plate rupture during a rolling process may be intensified. Therefore, Si may be contained in an amount of 2.0 to 4.5 wt %. Specifically, it may be contained in an amount of 2.5 to 4.0 wt %.

C at 0.005 wt % or less

Carbon (C) is an austenite stabilizing element, and it refines a coarse columnar structure occurring during a continuous casting process and suppresses a slab center segregation of S. It also promotes work-hardening of the steel sheet during cold rolling, thereby promoting the formation of secondary recrystallization nuclei in the {110}<001> orientation in the steel sheet. However, when it remains in a final product, it must be controlled to an appropriate content because it is an element that deteriorates magnetic properties by precipitating carbides formed due to a magnetic aging effect in a product plate. In the embodiment of the present invention, during the primary recrystallization annealing in the manufacturing process, a decarburization process is performed, and the C content in the final electrical steel sheet prepared after the decarburization annealing may be 0.005 wt % or less. More specifically, it may be 0.003 wt % or less.

C of 0.001 to 0.1 wt % may be included in the slab. When the slab contains too little C, phase transformation between austenite does not sufficiently occur, causing unevenness of the slab and the hot rolled microstructure. As a result, cold rolling properties are also deteriorated. When it contains too much C, sufficient decarburization may not be obtained in a decarburization process. Therefore, due to the phase transformation phenomenon caused by this, the secondary recrystallized texture is severely damaged. In addition, an edge crack of a hot rolled sheet may occur. More specifically, C at 0.01 to 0.1 wt % may be included in the slab.

Mn at 0.001 to 0.08 wt %

Manganese (Mn) has the effect of reducing the iron loss by increasing the specific resistance, like Si. Conventionally, it has been known that it reacts with S in steel to form MnS precipitates to suppress grain growth. However, when MnS alone is formed, a large amount of precipitate is formed, and thus, it does not play a sufficient role as a grain growth inhibitor. For that reason, in order to secure a desired suppression force, many MnS precipitate forming elements were added, thereby causing a problem of heating a slab to a high temperature. In the embodiment of the present invention, it is not necessary to add a large amount of Mn content because a sulfide or selenide containing Fe, Mn, and Cu is formed as a precipitate. In contrast, when a large amount of Mn is added, MnS or MnSe precipitates are coarsely precipitated, so that grain growth inhibiting force is deteriorated. When too little Mn is contained, formation of FeS and FeSe precipitates are promoted, however, although these precipitates have an excellent grain growth inhibiting force, they undergo a phase change to a liquid phase at a interface during hot rolling, thereby increasing the edge crack, resulting in a problem of reduced hot rolling productivity. Therefore, Mn may be contained in an amount of 0.001 to 0.08 wt %. Specifically, it may be contained in an amount of 0.005 to 0.08 wt %.

P at 0.001 to 0.1 wt %

Phosphorus (P) is segregated at a grain boundary and has an effect of inhibiting grain growth, and it promotes the recrystallization of {111}<112> oriented grains during the primary recrystallization to form a microstructure suitable for the formation of secondary recrystallization of the Goss-oriented grains. When too little P is contained, the above-described effect may not be properly obtained. When too much P is contained, occurrence of sheet rupture increases during cold rolling, and a cold rolling actual yield may decrease. Therefore, P may be contained in an amount of 0.001 to 0.1 wt %. Specifically, it may be contained in an amount of 0.005 to 0.05 wt %.

Cu at 0.001 to 0.1 wt %

Like Mn, copper (Cu) reacts with S and Se to form CuS or CuSe precipitates to suppress grain growth. It is easier to form a precipitate together with Mn than when it exists alone, and has an effect of reducing the amount of the precipitate. Therefore, it is an essential alloying element to form (Fe,Mn,Cu)S precipitates and (Fe,Mn,Cu)Se precipitates, and it has a great effect of inhibiting grain growth by refining the precipitates, and since it exists relatively stably even at a higher temperature than that of MnS and FeS, the grain growth inhibiting force is maintained to a high temperature such that secondary recrystallization is stably formed. When an amount of Cu added is too small, the above-described effect may not be sufficiently obtained. When too much Cu is added, the effect of inhibiting the grain growth is deteriorated because coarse CuS or CuSe precipitates are formed. Therefore, Cu may be contained in an amount of 0.001 to 0.1 wt %. Specifically, it may be contained in an amount of 0.005 to 0.09 wt %.

S at 0.0005 to 0.05 wt %

Sulfur (S) is known as an element having an effect of inhibiting grain growth by being segregated alone in a grain boundary or by reacting with Fe, Mn, Cu, etc. in steel to form FeS, MnS, and CuS. Conventionally, a method in which MnS alone was used or it was used together with CuS was used, or FeS precipitate was used as a grain growth inhibitor, but in the embodiment of the present invention, (Fe,Mn,Cu)S composite precipitates, which are precipitated by reaction of these alloy elements, are used as a grain growth inhibitor. In order to form the (Fe,Mn,Cu)S composite precipitates, it is important that Mn and Cu are appropriately added without excessive addition and S is sufficiently added. When too little S is added, (Fe,Mn,Cu)S precipitates are not sufficiently formed, so it is difficult to secure a desired grain growth inhibiting force. When too much S is added, an edge crack of the hot rolled sheet may occur. Therefore, S may be contained in an amount of 0.0005 to 0.05 wt %. Specifically, it may be contained in an amount of 0.001 to 0.03 wt %.

Se at 0.0005 to 0.05 wt %

Similar to S, selenium (Se) is segregated at grain boundaries or forms precipitates such as MnSe, so that it inhibits movement at the grain boundaries. In the embodiment of the present invention, Se having such properties is an important alloy element for forming stable secondary recrystallization by strongly inhibiting the growth of primary recrystallized grains by reacting with Fe, Mn, and Cu to form (Fe,Mn,Cu)Se composite precipitates. In the embodiment of the present invention, a strong grain growth inhibiting force may be secured by forming not only (Fe,Mn,Cu)S but also (Fe,Mn,Cu)Se precipitates together by adding S and Se together. Particularly, Se has a heavier atomic weight than S, so (Fe,Mn,Cu)Se precipitates are much more stable than (Fe,Mn,Cu)S precipitates, and secondary recrystallization is stably formed. When too little Se is added, (Fe,Mn,Cu)Se precipitates are not sufficiently formed, so it is difficult to secure a desired grain growth inhibiting force. When too much Se is added, an edge crack of the hot rolled sheet may occur. Therefore, Se may be contained in an amount of 0.0005 to 0.05 wt %. Specifically, it may be contained in an amount of 0.001 to 0.03 wt %.

In the embodiment of the present invention, a sum amount of S and Se is 0.005 to 0.05 wt %. When the sum amount of S and Se is too small, (Fe,Mn,Cu)Se precipitates and (Fe,Mn,Cu)S precipitates are not properly formed, and it is difficult to secure a grain growth inhibiting force, so secondary recrystallization is not properly formed. When the sum amount of S and Se is too large, an edge crack of the hot rolled sheet may occur. Specifically, S and Se may be contained in an amount of 0.01 to 0.05 wt %.

B at 0.0001 to 0.01 wt %

Boron (B) is an effective element for inhibiting defects and crack propagation at grain boundaries to reduce occurrence of an edge crack during hot rolling, by reacting with N in steel to form BN precipitates to inhibit grain growth and by being segregated at the grain boundaries to enhance bonding force of the grain boundaries. When S and Se are compositely added as in the present invention, it is important to properly add a content of B in order to minimize possibility of occurrence of edge cracks. When too little B is contained, the above-described effect may not be sufficiently obtained. When too much B is added, high temperature brittleness may be increased due to formation of an intermetallic compound. Therefore, B may be contained in an amount of 0.0001 to 0.01 wt %. Specifically, it may be contained in an amount of 0.0005 to 0.01 wt %. More specifically, B may be contained in an amount of 0.0011 to 0.01 wt %. More specifically, B may be contained in an amount of 0.0015 to 0.01 wt %.

Mo at 0.01 to 0.2 wt %

Molybdenum (Mo) is an alloy element that inhibits high temperature grain boundary oxidation, and is effective in reducing high temperature cracks and edge cracks in slab continuous casting and hot rolling processes. In addition, it has an effect of increasing a magnetic flux density by increasing a

Goss texture of a {110}<001> orientation in the hot rolling process. When too little Mo is contained, edge cracks due to the addition of S and Se may occur, or secondary recrystallization may not be properly formed. When too much Mo is contained, magnetism deteriorates. Therefore, Mo may be contained in an amount of 0.01 to 0.2 wt %. Specifically, it may be contained in an amount of 0.02 to 0.2 wt %.

The grain-oriented electrical steel sheet according to the embodiment of the present invention may further contain Al at 0.0001 to 0.01 wt % and N at 0.0005 to 0.005 wt %.

Aluminum (Al) is combined with nitrogen in steel to form an AlN precipitate, so in the embodiment of the present invention, the Al content is actively inhibited to avoid formation of Al-based nitride or oxide. When too much Al is contained, since the formation of the AlN and Al₂O₃ is promoted, a purification annealing time for eliminating it increases, and the AlN precipitate and inclusions such as Al₂O₃ that have not been eliminated remain in a final product, which increases a coercive force, and thus the iron loss may increase. However, it is most ideal to completely exclude the Al content, but when considering that it is inevitably contained considering the steel making process, Al may be contained in an amount of 0.0001 to 0.01 wt %.

Nitrogen (N) is an element that reacts with Al and Si to form AlN and Si₃N₄ precipitates. In addition, it may react with B to form BN. In the embodiment of the present invention, since AlN is not used as a grain growth inhibitor, Al is not added in the steel making process, so N is not specifically added. B is added to increase the grain boundary bonding force, and an effect of inhibiting grain growth by BN precipitates formed by reacting with N may also be expected. For this reason, an upper limit of N is limited to a maximum of 0.005 wt % to inhibit the grain growth due to the precipitation of BN and secure the effect of strengthening the grain boundary binding force of B itself. In addition, although it is preferable to minimally add N, N may be contained in an amount of 0.0005 to 0.005 wt % because a denitrification load of the steel making process is significantly increased to manage N to less than 0.0005 wt % in the steel making step.

The grain-oriented electrical steel sheet according to the embodiment of the present invention may further contain at least one of Cr at 0.001 to 0.1 wt %, Sn at 0.005 to 0.2 wt %, and Sb at 0.005 to 0.2 wt %.

Chromium (Cr) is an alloy element with a higher affinity for oxygen than other alloy elements, and reacts with oxygen during a decarburization process to form Cr₂O₃ on a surface of the steel sheet surface. Such an oxide layer serves as a passage for carbon to diffuse to the surface of the steel, thereby making decarburization easier, and a surface oxide layer reacts with MgO, which is an annealing separator, to increase adhesion of the steel sheet when forming base coating. When too little Cr is added, there is no addition effect. When too much Cr is added, it may react with carbon in the steel to form chromium carbide, which may degrade the decarburization performance. Therefore, when chromium is further added, it may be added in an amount of 0.001 to 0.1 wt %.

Tin (Sn) and antimony (Sb) are representative grain boundary segregation elements together with P, and have an effect of increasing a magnetic flux density by promoting the nucleation of {110}<001> Goss orientation in the hot rolling process. When too much Sn and Sb are added, cold rolled sheet rupture and decarburization are delayed due to grain boundary oversegregation, thereby forming an uneven primary recrystallized microstructure and deteriorating magnetic properties. In addition, when too little of Sn and Sb is added, the effect on the formation of Goss orientation recrystallized grains may be weakened. Therefore, Sn and Sb may be added in an amount of 0.005 to 0.2 wt %, respectively.

Impurity element

In addition to the above elements, impurities such as Ti, Mn, and Ca, which are inevitably added, may be contained. They react with oxygen or nitrogen to form fine oxides and nitrides, which have an undesirable effect on magnetism, and thus these contents are limited to 0.003 wt % or less, respectively.

In the embodiment of the present invention, by controlling the Mn, S, Se, Cu, B, and Mo components in the alloy component, it is possible to further improve productivity and magnetism. Specifically, the iron loss in a condition of 1.7 Tesla and 50 Hz of the grain-oriented electrical steel sheet may be 0.95 W/kg or less. A magnetic flux density (B10) induced under the magnetic field of 1000 Nm of the grain-oriented electrical steel sheet may be 1.88 T or more. Specifically, it may be 1.91 to 1.95 T.

A manufacturing method of a grain-oriented electrical steel sheet according to an embodiment of the present invention includes: preparing a slab; heating the slab; hot rolling the slab to preparing a hot rolled sheet; cold rolling the hot rolled sheet to prepare a cold rolled sheet; first recrystallization annealing the cold rolled sheet; and second recrystallization annealing the cold rolled sheet in which the first recrystallization annealing is completed.

Hereinafter, each step will be described in detail.

First, a slab is prepared.

In the steel making process, Si, C, Mn, S, Se, Cu, B, and Mo may be controlled to an appropriate amount, and alloy elements, which are advantageous for forming a Goss texture, may be added as necessary. Molten steel whose components have been adjusted in the steel making process is prepared into a slab through continuous casting.

Each composition of the slab has been described in detail in the above-described grain-oriented electrical steel sheet, so a duplicate description thereof is omitted. Equations 1 to 3 described above may be identically satisfied even in an alloy component of the slab.

Next, the slab is heated. The heating of the slab may be performed at a temperature of 1050 to 1300° C.

Next, a hot rolled sheet is prepared by hot rolling the slab. A hot rolled sheet having a thickness of 1.5 to 4.0 mm may be prepared by the hot rolling. As described above, in the embodiment of the present invention, by controlling the contents of Mn, S, Se, Cu, B, and Mo, edge cracks of the hot rolled sheet may be reduced. Specifically, the edge crack formed on the hot rolled sheet may have a maximum depth of 20 mm or less. The maximum depth of the edge crack means the deepest of the edge cracks formed over an entire length of the hot rolled sheet. The depth of the edge crack means a length of the edge crack measured from an end of the steel sheet in a rolling vertical direction (TD direction) to a center of the steel sheet. In the embodiment of the present invention, as the edge crack is reduced, an actual yield of the steel sheet increases.

The hot rolled sheet may be subjected to hot rolled sheet annealing or may be subjected to cold rolling without performing hot rolled sheet annealing, as necessary. In the case of performing the hot rolled sheet annealing, in order to make a hot rolled structure uniform, it may be heated to a temperature of 900° C. or higher, and then cooled.

Next, a cold rolled sheet is prepared by cold rolling the hot rolled sheet. The cold rolling is performed by using a reverse mill or a tandem mill by one cold rolling process or two or more cold rolling processes including intermediate annealing to prepare a cold rolled sheet having a final product thickness. It is advantageous to improve the magnetic property to perform warm rolling while maintaining a temperature of the steel sheet at 100° C. or higher during the cold rolling.

Next, the cold rolled cold-rolled sheet is subjected to primary recrystallization annealing. In the primary recrystallization annealing process, primary recrystallization occurs in which nuclei of Goss oriented grains are generated. In the primary recrystallization annealing process, decarburization of the steel sheet may be performed. For the decarburization, it may be performed at a dew point temperature of 50° C. to 70° C. and in a mixed atmosphere of hydrogen and nitrogen. The primary recrystallization annealing temperature may be 750° C. or higher. When the annealing temperature is low, decarburization may take a long time. When the annealing temperature is high, the primary recrystallized grains grow coarse, and grain growth driving force is lowered, so that stable secondary recrystallization is not formed. In addition, an annealing time is not a particular problem for the effect of the present invention, but may be set to 30 minutes or more. In the embodiment of the present invention, only decarburization is performed, and nitriding may not be performed. That is, the primary recrystallization annealing may be performed only at a dew point temperature of 50° C. to 70° C. and in a mixed atmosphere of hydrogen and nitrogen. By the primary recrystallization annealing, an average particle size of the primary recrystallization may be 5 pm or more.

The cold rolled sheet subjected to the primary recrystallization annealing includes S- and Se-based precipitates, and is used as a grain growth inhibitor during secondary recrystallization annealing. Specifically, the S- and Se-based precipitates may include one or more precipitates of (Fe,Mn,Cu)S and (Fe,Mn,Cu)Se. The (Fe,Mn,Cu)S means a composite precipitate in which S and Fe, Mn, and Cu are combined.

Next, the cold rolled sheet in which the primary recrystallization annealing is completed is subjected to the second recrystallization annealing. In this process, a Goss {110}<001> texture is formed in which a {110} plane is parallel to the rolling plane and a <001> direction is parallel to the rolling direction. In this case, after an annealing separator is applied to the cold rolled sheet in which the primary recrystallization annealing is completed, the secondary recrystallization annealing may be performed. In this case, the annealing separator is not particularly limited, and an annealing separator containing MgO as a main component may be used.

In the secondary recrystallization annealing, a temperature is increased at an appropriate heating rate to form the second recrystallization of a {110}<001> Goss orientation, and then, after purification annealing, which is an impurity removal process, it is cooled. In the process, an annealing atmosphere gas is heat-treated using a mixed gas of hydrogen and nitrogen during the temperature rising process as in the general case, and 100% hydrogen gas is used in the purification annealing for a long time to remove impurities. When using the (Fe,Mn,Cu)S and (Fe,Mn,Cu)Se precipitates as a grain growth inhibitor without using the AlN precipitates as the main grain growth inhibitor as in the embodiment of the present invention, since the formation temperature of secondary recrystallization is not higher than that in the case of using the AlN precipitates, it is possible to manufacture a grain-oriented electrical steel sheet having excellent magnetism even when subjected to high temperature annealing that heats and soaks only at a temperature of 950° C. or higher.

Hereinafter, preferred examples of the present invention and comparative examples will be described. However, the following examples are only preferred examples of the present invention, and the present invention is not limited to the following examples.

### EXAMPLE 1

A slab containing, in a unit of wt %, C at 0.055 wt %, Si at 3.2 wt %, P at 0.03 wt %, Cu at 0.05 wt %, Sn at 0.04 wt %, B at 0.005 wt %, Mo at 0.1 wt %, Cr at 0.05 wt %, and N at 0.003 wt % as a basic composition, and in which contents of Mn, S, and Se were added as shown in Table 1 below, and containing the remainder Fe and other inevitable impurities, was prepared. Subsequently, the slab was heated to 1250° C. and then hot rolled to prepare a 2.3 mm thick hot rolled sheet. The hot rolled sheet was heated at a temperature of 1085° C., and then soaked at 950° C. for 120 seconds to anneal the hot rolled sheet. Next, after pickling the annealed hot rolled sheet, it is cold rolled to a thickness of 0.30 mm, and the primary recrystallization annealing together with decarburization was performed for the cold rolled steel sheet by maintaining it at a temperature of 830° C. for 180 seconds in a mixed gas atmosphere of hydrogen and nitrogen at a dew point of 60° C. After applying MgO, which is an annealing separator, to this steel sheet, the secondary recrystallization annealing was performed therefor, wherein the secondary recrystallization annealing was performed in a mixed gas atmosphere of “25 v % nitrogen+75 v % hydrogen” up to 1200° C. and in a gas atmosphere of 100 v % hydrogen after reaching 1200° C. during 20 hours, and then was furnace-cooled. Table 1 shows the magnetic properties of the grain-oriented electrical steel sheet according to each component.

The iron loss was measured under the condition of 1.7 Tesla and 50 Hz using a single sheet measurement method, and the magnetic flux density (Tesla) induced under the magnetic field of 800 A/m was measured. Each iron loss value was an average of each condition.

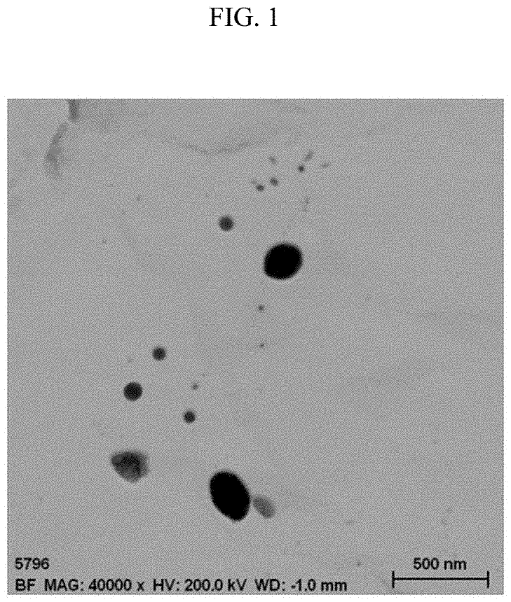

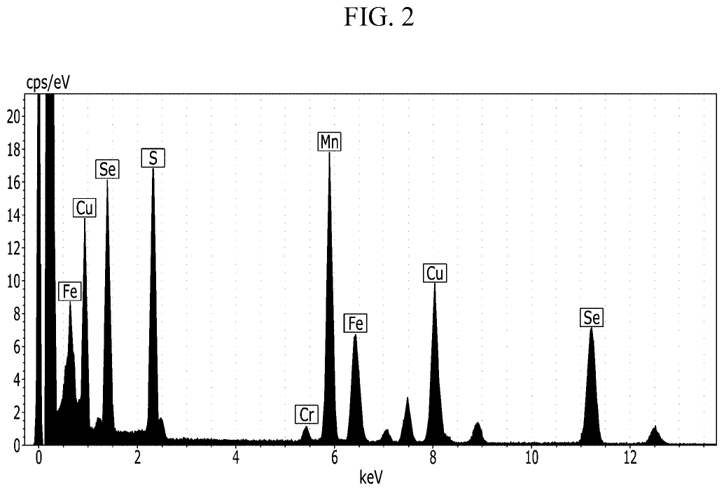

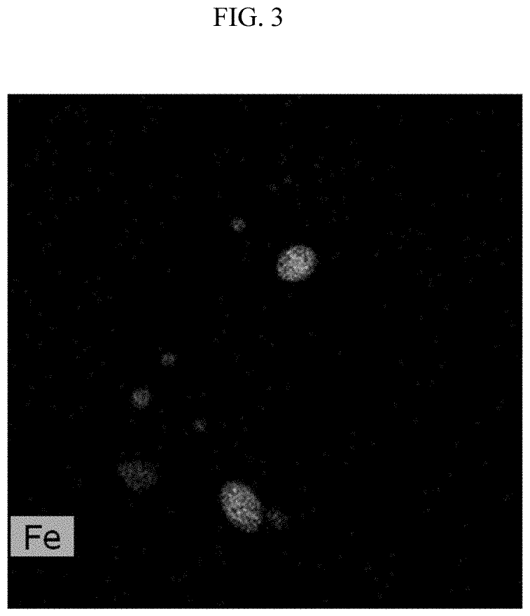

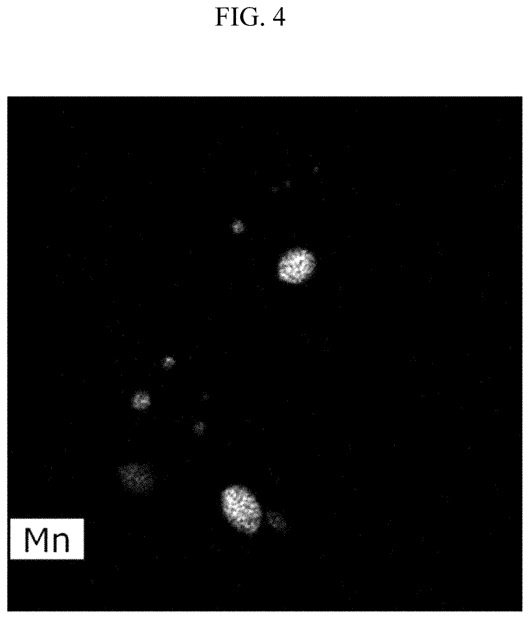

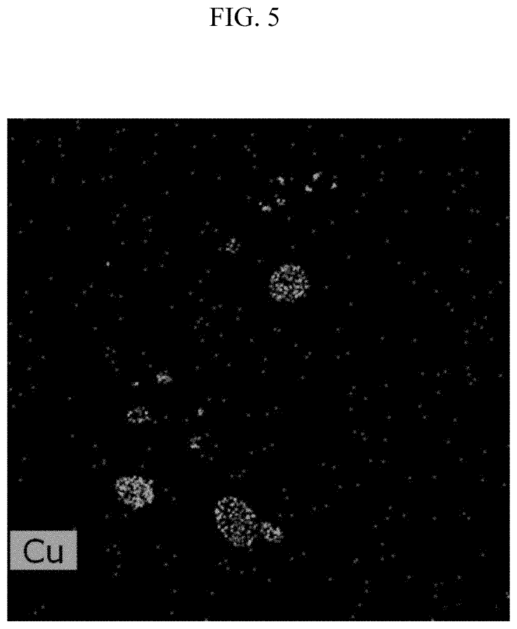

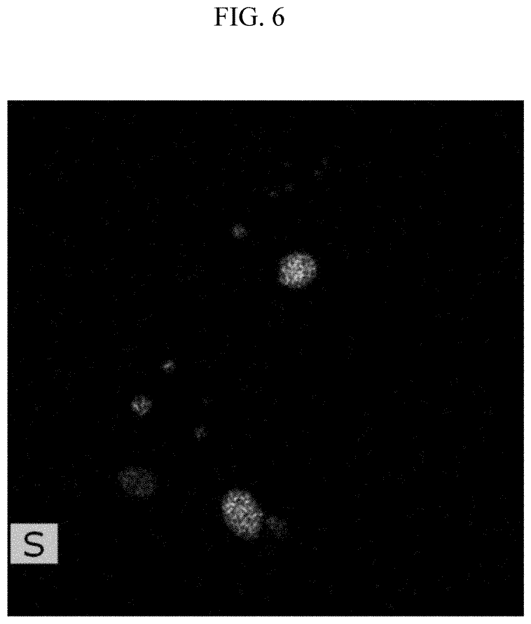

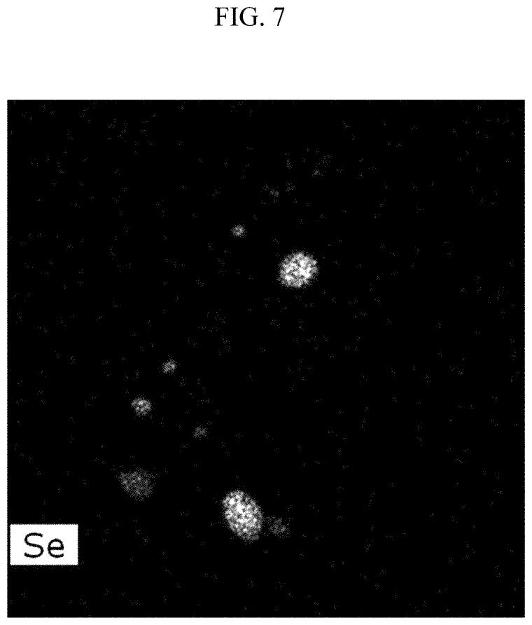

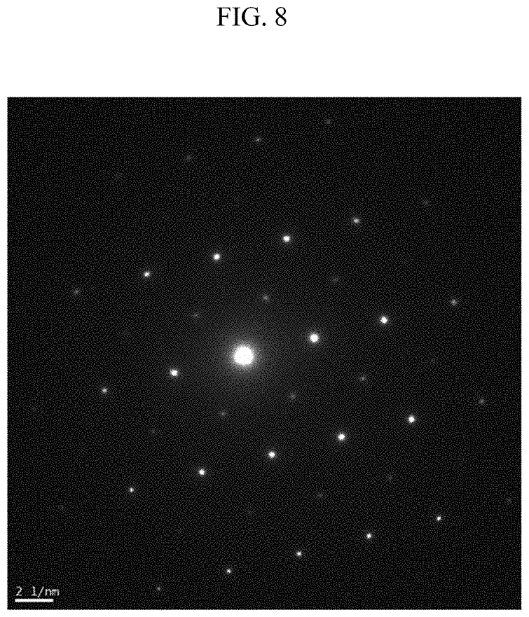

FIG. 1 illustrates a photograph of a TEM precipitate immediately before secondary recrystallization in a preparing process of Inventive Material 5. FIG. 2 illustrates a component analysis graph of the precipitate in FIG. 1. As illustrated in FIG. 2, it can be seen that Fe, Mn, and Cu alloy elements reacted with S and Se. For more detailed analysis, results of mapping respective Fe, Mn, Cu, S, and Se components are shown in FIG. 3 to FIG. 7. As shown in the drawings, it can be confirmed that the Fe, Mn, and Cu alloy elements and S and Se were observed at the same time in all precipitates, so no added alloy components form a sole sulfide or selenide, but existed as (Fe,Mn,Cu)S precipitates or (Fe,Mn,Cu)Se precipitates. In FIG. 8, a cubic grain structure such as MnS was found through a photograph of a lattice diffraction pattern for these precipitates. In view of the above analysis, it can be confirmed that the added Mn and Cu alloy elements did not form independent MnS and CuS or MnSe and CuSe, but formed (Fe,Mn,Cu)S precipitates or (Fe,Mn,Cu)Se precipitates containing all of Fe, Mn, and Cu.

TABLE 1

| | | | | | Magnetic | Iron loss | | |
|---|---|---|---|---|---|---|---|---|
| Classification | | | | | flux density | (W17/50, | Edge | |
| (wt %) | Mn | S | Se | S + Se | (B10, Tesla) | W/kg) | Crack | |
| Comparative | 0.0008 | 0.005 | 0.005 | 0.01 | 1.855 | 1.31 | ≤20 | mm |
| Material 1 | | | | | | | | |
| Comparative | 0.005 | 0.005 | 0.0003 | 0.0053 | 1.849 | 1.37 | ≤20 | mm |
| Material 2 | | | | | | | | |
| Comparative | 0.005 | 0.0003 | 0.006 | 0.0063 | 1.864 | 1.3 | ≤20 | mm |
| Material 3 | | | | | | | | |
| Comparative | 0.01 | 0.002 | 0.002 | 0.004 | 1.809 | 1.42 | ≤20 | mm |
| Material 4 | | | | | | | | |
| Inventive | 0.01 | 0.005 | 0.005 | 0.01 | 1.911 | 0.99 | ≤20 | mm |
| Material 1 | | | | | | | | |
| Inventive | 0.02 | 0.01 | 0.005 | 0.015 | 1.925 | 0.97 | ≤20 | mm |
| Material 2 | | | | | | | | |
| Inventive | 0.03 | 0.01 | 0.015 | 0.025 | 1.933 | 0.95 | ≤20 | mm |
| Material 3 | | | | | | | | |
| Inventive | 0.04 | 0.015 | 0.015 | 0.03 | 1.929 | 0.96 | ≤20 | mm |
| Material 4 | | | | | | | | |
| Inventive | 0.05 | 0.015 | 0.02 | 0.035 | 1.932 | 0.95 | ≤20 | mm |
| Material 5 | | | | | | | | |
| Inventive | 0.06 | 0.02 | 0.02 | 0.04 | 1.935 | 0.94 | ≤20 | mm |
| Material 6 | | | | | | | | |
| Inventive | 0.07 | 0.025 | 0.02 | 0.045 | 1.928 | 0.96 | ≤20 | mm |
| Material 7 | | | | | | | | |
| Inventive | 0.08 | 0.03 | 0.02 | 0.05 | 1.917 | 0.98 | ≤20 | mm |
| Material 8 | | | | | | | | |
| Comparative | 0.08 | 0.055 | 0.005 | 0.06 | 1.853 | 1.07 | >20 | mm |
| Material 5 | | | | | | | | |
| Comparative | 0.08 | 0.005 | 0.053 | 0.058 | 1.828 | 1.19 | >20 | mm |
| Material 6 | | | | | | | | |
| Comparative | 0.09 | 0.025 | 0.025 | 0.05 | 1.785 | 1.53 | ≤20 | mm |
| Material 7 | | | | | | | | |

As can be seen in Table 1, when S and Se were contained in an appropriate amount, both the magnetic flux density and iron loss were excellent. In addition, the occurrence size of edge cracks in the hot rolled sheet was good at 20 mm or less. However, in the case of Comparative Materials 5 and 6, in which the total contents of S and Se exceeded 0.05 wt %, the edge cracks exceeded 20 mm, and the magnetism also deteriorated. When the content of Mn exceeded 0.08 wt %, it can be confirmed that the grain growth inhibiting effect was lowered by coarse MnS and MnSe precipitation rather than (Fe,Mn,Cu)S and (Fe,Mn,Cu)Se precipitation, so stable secondary recrystallization was not formed, thus the magnetism deteriorated.

### EXAMPLE 2

A slab containing, in a unit of wt %, C at 0.050 wt %, Si at 3.2 wt %, P at 0.02 wt %, Mn at 0.05 wt %, Sn at 0.04 wt %, B at 0.003 wt %, Mo at 0.05 wt %, Cr at 0.04 wt %, N at 0.003 wt %, S at 0.020 wt %, and Se at 0.025 wt % as a basic composition, and in which a content of Cu was added as shown in Table 2 below, and containing the remainder Fe and other inevitable impurities, was prepared. Subsequently, the slab was heated to 1230° C. and then hot rolled to prepare a 2.0 mm thick hot rolled sheet. The hot rolled sheet was heated at a temperature of 1000° C., and then soaked for 120 seconds to anneal the hot rolled sheet. Next, after pickling the annealed hot rolled sheet, it was cold rolled to a thickness of 0.23 mm, and the primary recrystallization annealing together with decarburization was performed for the cold rolled steel sheet by maintaining it at a temperature of 820° C. for 180 seconds in a mixed gas atmosphere of hydrogen and nitrogen at a dew point of 60° C. After applying MgO, which is an annealing separator, to this steel sheet, the secondary recrystallization annealing was performed therefor, wherein the secondary recrystallization annealing was performed in a mixed gas atmosphere of “50 v % nitrogen+50 v % hydrogen” up to 1150° C. and in a gas atmosphere of 100 v % hydrogen after reaching 1150° C. during the 20 hours, and then was furnace-cooled. Table 2 shows the magnetic properties of the grain-oriented electrical steel sheet according to each component.

TABLE 2

| | | Magnetic | Iron loss | |
|---|---|---|---|---|
| | | flux density | (W17/50, | Edge |
| Classification | Cu(wt %) | (B10, Tesla) | W/kg) | Crack |
| Comparative | 0.0005 | 1.873 | 1.07 | ≤20 mm |
| Material 8 | | | | |
| Inventive | 0.005 | 1.915 | 0.88 | ≤20 mm |
| Material 9 | | | | |
| Inventive | 0.01 | 1.932 | 0.83 | ≤20 mm |
| Material 10 | | | | |
| Inventive | 0.02 | 1.938 | 0.82 | ≤20 mm |
| Material 11 | | | | |
| Inventive | 0.03 | 1.936 | 0.81 | ≤20 mm |
| Material 12 | | | | |
| Inventive | 0.05 | 1.941 | 0.8 | ≤20 mm |
| Material 13 | | | | |
| Inventive | 0.07 | 1.918 | 0.86 | ≤20 mm |
| Material 14 | | | | |
| Inventive | 0.09 | 1.912 | 0.88 | ≤20 mm |
| Material 15 | | | | |
| Comparative | 0.11 | 1.898 | 0.96 | ≤20 mm |
| Material 9 | | | | |

As can be seen in Table 2, the magnetism deteriorated in the case of Comparative Material 8 in which too little Cu content was added, and it was determined that (Fe,Mn,Cu)S and (Fe,Mn,Cu)Se precipitates were not finely precipitated as less Cu was added. In contrast, it can be confirmed that in the case of Comparative Material 9 in which the Cu content was excessively added, the CuS and CuSe precipitates in which Cu was mostly contained rather than the (Fe,Mn,Cu)S and (Fe,Mn,Cu)Se precipitates, were mainly coarsely formed and thus the magnetism deteriorated.

### EXAMPLE 3

A slab containing, in a unit of wt %, C at 0.06 wt %, Si at 3.3 wt %, Mn at 0.05 wt %, S at 0.015 wt %, Se at 0.035 wt %, P at 0.02 wt %, Cu at 0.03 wt %, Sn at 0.06 wt %, Cr at 0.08 wt %, and N at 0.004 wt % as a basic composition, and in which contents of B and Mo were added as shown in Table 3 below, and containing the remainder Fe and other inevitable impurities, was prepared.

Subsequently, the slab was heated to 1280° C. and then hot rolled to prepare a 2.0 mm thick hot rolled sheet. In this case, a maximum depth was measured among the edge cracks observed from both sides of the hot rolled sheet, and then it cut to an appropriate size for annealing. The hot rolled sheet was heated at a temperature of 1100° C., and then soaked for 120 seconds to anneal the hot rolled sheet. Next, after pickling the annealed hot rolled sheet, it was cold rolled to a thickness of 0.23 mm, and the primary recrystallization annealing together with decarburization was performed for the cold rolled steel sheet by maintaining it at a temperature of 850° C. for 180 seconds in a mixed gas atmosphere of hydrogen and nitrogen at a dew point of 60° C. After applying MgO, which is an annealing separator, to this steel sheet, the secondary recrystallization annealing was performed therefor, wherein the secondary recrystallization annealing was performed in a mixed gas atmosphere of “25 v % nitrogen+75 v % hydrogen” up to 1200° C. and in a gas atmosphere of 100 v % hydrogen after reaching 1200° C. during 15 hours, and then was furnace-cooled. Table 3 shows the magnetic properties of the grain-oriented electrical steel sheet according to each component.

TABLE 3

| | | | Edge | Magnetic | Iron loss |
|---|---|---|---|---|---|
| | B | Mo | Crack | flux density | (W17/50, |
| Classification | (wt %) | (wt %) | (mm) | (B10, Tesla) | W/kg) |
| Comparative | <0.0001 | 0.05 | 29 | 1.901 | 0.91 |
| Material 10 | | | | | |
| Comparative | <0.0001 | 0.2 | 23 | 1.875 | 0.96 |
| Material 11 | | | | | |
| Inventive | 0.0005 | 0.02 | 20 | 1.912 | 0.87 |
| Material 16 | | | | | |
| Inventive | 0.0005 | 0.1 | 15 | 1.922 | 0.85 |
| Material 17 | | | | | |
| Inventive | 0.0011 | 0.03 | 16 | 1.927 | 0.83 |
| Material 18 | | | | | |
| Inventive | 0.0015 | 0.1 | 12 | 1.928 | 0.84 |
| Material 19 | | | | | |
| Inventive | 0.0035 | 0.15 | 9 | 1.933 | 0.81 |
| Material 20 | | | | | |
| Inventive | 0.007 | 0.2 | 5 | 1.941 | 0.8 |
| Material 21 | | | | | |
| Comparative | 0.009 | 0.25 | 2 | 1.906 | 0.9 |
| Material 12 | | | | | |
| Inventive | 0.01 | 0.15 | 4 | 1.939 | 0.81 |
| Material 21 | | | | | |
| Comparative | 0.01 | 0.005 | 25 | 1.899 | 0.92 |
| Material 13 | | | | | |
| Comparative | 0.011 | 0.15 | 2 | 1.853 | 0.98 |
| Material 14 | | | | | |

As shown in Table 3, Comparative Materials 10 to 14, in which B or Mo was not contained in an appropriate amount, had a maximum hot rolled edge crack occurrence depth of 28 mm, leading to an increase in an amount of hot rolled edge cutting by the edge crack, resulting in poor productivity. Particularly, Comparative Material 14 in which the B content was excessively added formed coarse BN precipitates, inhibiting the formation of secondary recrystallization of the Goss oriented grains, resulting in poor magnetic properties. Even in the case of Mo, Comparative Material 12 in which it was excessively added had poor magnetism, and it can be confirmed that the secondary recrystallization of the Goss orientation become unstable due to excessive development of the shear texture during the hot rolling.

The present invention may be embodied in many different forms, and should not be construed as being limited to the disclosed embodiments. In addition, it will be understood by those skilled in the art that various changes in form and details may be made thereto without departing from the technical spirit and essential features of the present invention. Therefore, it is to be understood that the above-described exemplary embodiments are for illustrative purposes only, and the scope of the present invention is not limited thereto.

1. A grain-oriented electrical steel sheet, comprising
in a unit of wt %, Si at 2.0 wt % to 4.5 wt %, C at 0.005 wt % or less (excluding 0 wt %), Mn at 0.001 wt % to 0.08 wt %, P at 0.001 wt % to 0.1 wt %, Cu at 0.001 wt % to 0.1 wt %, S at 0.0005 wt % to 0.05 wt %, Se at 0.0005 wt % to 0.05 wt %, B at 0.0001 wt % to 0.01 wt %, Mo at 0.01 wt % to 0.2 wt %, and the remainder of Fe and inevitable impurities,
wherein a sum amount of S and Se is 0.005 to 0.05 wt %.

2. The grain-oriented electrical steel sheet of claim 1, further comprising
B at 0.0011 to 0.01 wt %.

3. The grain-oriented electrical steel sheet of claim 1, further comprising
Al at 0.0001 to 0.01 wt % and N at 0.0005 to 0.005 wt %.

4. The grain-oriented electrical steel sheet of claim 1, further comprising
at least one of Cr at 0.001 to 0.1 wt %, Sn at 0.005 to 0.2 wt %, and Sb at 0.005 to 0.2 wt %.

5. A manufacturing method of a grain-oriented electrical steel sheet, comprising:
preparing a slab that contains, in a unit of wt %, Si at 2.0 wt % to 4.5 wt %, C at 0.005 wt % or less (excluding 0 wt %), Mn at 0.001 wt % to 0.08 wt %, P at 0.001 wt % to 0.1 wt %, Cu at 0.001 wt % to 0.1 wt %, S at 0.0005 wt % to 0.05 wt %, Se at 0.0005 wt % to 0.05 wt %, B at 0.0001 wt % to 0.01 wt %, Mo at 0.01 wt % to 0.2 wt %, and the remainder of Fe and inevitable impurities, and in which a sum amount of S and Se is 0.005 to 0.05 wt %;
heating the slab;
hot rolling the slab to prepare a hot rolled sheet;
cold rolling the hot rolled sheet to prepare a cold rolled sheet;
primary recrystallization annealing the cold rolled sheet; and
secondary recrystallization annealing the cold rolled sheet in which the first recrystallization annealing is completed.

6. The manufacturing method of the grain-oriented electrical steel sheet of claim 5, wherein
after the preparing of the hot rolled sheet, the hot rolled sheet has an edge crack maximum depth of 20 mm or less.

7. The manufacturing method of the grain-oriented electrical steel sheet of claim 5, wherein
the cold rolled sheet in which the first recrystallization annealing is completed includes one or more precipitates of (Fe,Mn,Cu)S and (Fe,Mn,Cu)Se.

8. The manufacturing method of the grain-oriented electrical steel sheet of claim 5, wherein
the primary recrystallization annealing is performed in a hydrogen and nitrogen mixed atmosphere at a dew point temperature of 50° C. to 70° C.
